(19) United States
(12) Patent Application Publication
(10) Pub. No.: US 2011/0315151 A1
(43) Pub. Date: Dec. 29, 2011

(54) Orthodontic Pain Shield

(75) Inventor: Kristin Annette Schabert, Gregory, MI (US)

(73) Assignee: Kristin Annette Schabert, Gregory, MI (US)

(21) Appl. No.: 13/170,460

(22) Filed: Jun. 28, 2011

Related U.S. Application Data
(60) Provisional application No. 61/359,308, filed on Jun. 28, 2010.

(51) Int. Cl. A61C 5/14; B65D 83/08; A61C 19/06; B29C 67/00; B65H 35/06; A61C 19/00; B65D 85/671

(52) U.S. Cl. 128/859; 242/590; 221/30; 264/157; 427/2.29; 225/39; 206/63.5

(57) ABSTRACT

The present invention is devices and methods for quick and easy management of pain caused by orthodontic appliances. These dispensing devices and methods allow the user to quickly and easily obtain a desired size of a strip or segment applied to the orthodontic appliance to shield the user's mouth so that the strips or segments are immediately ready for use and take the mess and guesswork out of preparing and applying the pain management material to the sites needed. The invention consists of wax, polymer or other biocompatible flexible material formed into either strips or individual pieces. These strips or individual pieces are applied to the orthodontic appliance to shield the user's mouth from painful contact with components of an orthodontic appliance. In addition, the orthodontic pain shield may use shape, color, flavoring and even the possibility of topical anesthetics or other medicaments to ameliorate or preferably eliminate the pain caused by the irritation of oral tissue in and around the mouth caused by contact with the components of orthodontic appliances. A key advantage of the present invention is that it can be immediately used straight from its packaging, without the need for shaping, flattening, molding or guessing the proper size of the strips or segments needed and avoids all the mess typically associated with the preparation and application of orthodontic wax. Another key advantage of the present invention is that it can easily cover large areas of a user's mouth up to and including an entire orthodontic appliance.

### BACKGROUND OF THE INVENTION

1. Field of the Invention

The invention relates to the field of orthodontics and dentistry and particularly to the management of pain and discomfort associated with wearing braces or other orthodontic appliances by applying a shield over the braces or other orthodontic appliance to prevent contact and irritation between the braces or orthodontic appliance and the user's mouth.

2. Description of Related Art

The American Association of Orthodontists, called the AAO, estimates that more than four million people in the United States and Canada wear braces every year. The number of people is increasing every year. Children are the main market for orthodontics although adults are using orthodontic devices in greater numbers.

As shown in FIG. 1, orthodontic appliances 2 such as braces, a common form of orthodontic appliance, typically have individual brackets 4 that are affixed to the user's teeth 6 and connected to each other by wire 8. These orthodontic appliances 2 cause large amounts of pain and discomfort due to the contact and abrasion on the user's lips, cheeks, tongue and inner tissues of the mouth, collectively “mouth” 10, due to contact between the orthodontic appliances 2 and the user's mouth 10 (FIG. 2). This pain has and continues to be the primary affliction of wearing braces or any other orthodontic appliance. All of the currently available products pose challenges and significant inconvenience in effort and time for all patients, especially children, which leaves a major need for a much quicker and easier method of pain management unfulfilled.

The state of the art for pain management of orthodontic appliances currently consists of either using wax or polymers to cover the areas of the appliance causing irritation. For wax, the art relates to tubes or dots of wax with some having colors with fruit or mint flavoring. For the wax dots, such as those sold under the brand “Wax Dots” by DenTek Oral Care, Inc. of Maryville, Tenn., the wax dots must be dispensed from the packaging. This is difficult for the patient to dispense from current packaging.

After the wax dots are dispensed, the wax dots must be carefully molded and shaped to cover a single small offending area to prevent further irritation. Covering a large area becomes a difficult and tedious process for the patient when pain management is needed in a large area such as an irritated area caused by a partial or full arch. In this case many wax dots would have to be removed from the packaging and molded separately and then applied separately. This process is not only messy, but time consuming as well. Significant effort and time is required to obtain relief with this method, which is often accompanied by frustration.

One other type of wax, silicone wax, is also available to be applied as a barrier between the braces and mouth. However, this material requires the surface it is applied to, such as the bracket 4, to be totally dry prior to application of the silicone wax. Needless to say, it is extremely difficult to maintain an application site completely dry in the mouth 10 and especially so if it is being used on children.

For the tubes of wax, the patient must block off a piece of wax from a tube shaped block of wax, try to gauge the correct size needed and then manipulate the wax by flattening and molding it to fit around the specific area of the orthodontic appliance 2 causing pain and discomfort. This is often a messy, time-consuming process that is error prone and often has to be repeated, especially when trying to cover large areas.

As mentioned, another method of trying to provide relief from the discomforts of wearing braces or other orthodontic appliances 2 involves the use of polymers to form a type of mouth guard that covers the brackets 4 or wires 8 of the orthodontic appliance 2. This method often requires significant effort in preparation with several cycles of heating and fitting often being required. The heating is usually accomplished by boiling water and submersing the polymer in the water to heat the polymer. The heated polymer is more pliable than the relatively cold polymer.

As stated above, many polymers must be heated to make it flexible enough to be applied. Typically, this heating is done by immersing the polymer in very hot or boiling water. Where very hot or boiling water is used to make the polymer flexible (e.g., to allow molding the polymer to make polymer mouth guards), for safety reasons many patients, particularly young patients, should not use this product on their own. As a result, these patients need assistance that is often unavailable when pain management is necessary. In addition, particularly for younger patients, the skill and dexterity needed to mold the polymer is beyond the ability of the patient.

As a result, these patients also need assistance to form the polymer into a usable form which assistance is often unavailable when pain management is necessary. The polymers that do not require heating are cumbersome, difficult to use and often are unseemly. In addition, the polymer methods are not flexible in application and therefore do not work for all cases.

For example a patented polymer device described in U.S. Pat. No. 6,080,923, entitled “Reusable Lip Guard for Brass and Woodwind Musicians Who Wear Braces” issued to Joel

Andrew Austin on Jun. 27, 2000, specifically cites the risk of burns with hot water and the need for several tries of the fit and form cycle to achieve the perfect fit and feel. In addition, as the teeth move over time as a result of the workings of the braces or other appliance, the fit will change and thus the shape and fitting process of the polymer will need to be repeated regularly. Many supplies are also needed for this device which makes it inconvenient and time consuming for the patient and unavailable to a significant portion of the patient population.

In summary, all methods currently in use leave a significant need for a device that is very quick and easy to apply and assists in better pain management for all patients. Additionally there is a need for a product in pain management that allows the patient to express their personality and enjoy the product.

### SUMMARY OF THE INVENTION

The present invention is devices and methods for quick and easy management of pain caused by orthodontic appliances. These dispensing devices and methods allow the user to quickly and easily obtain a desired size of a strip or segment applied to the orthodontic appliance to shield the user's mouth so that the strips or segments are immediately ready for use and take the mess and guesswork out of preparing and applying the pain management material to the sites needed. A key advantage of the present invention is that it can be immediately used straight from its packaging, without the need for shaping, flattening, molding or guessing the proper size of the strips or segments needed and avoids all the mess typically associated with the preparation and application of orthodontic wax.

The invention consists of wax, polymer or other biocompatible flexible material formed into either strips or individual pieces. These strips or individual pieces are applied to the orthodontic appliance to shield the user's mouth from painful contact with components of an orthodontic appliance. In addition, the orthodontic pain shield may use shape, color, flavoring and even the possibility of topical anesthetics or other medicaments to ameliorate or preferably eliminate the pain caused by the irritation of oral tissue in and around the mouth caused by contact with the components of orthodontic appliances.

Methods and devices for dispensing the strips or segments are disclosed. The dispensing method and form of the strips or segments allows for much quicker and easier application for relief of pain for all patients regardless of age. One embodiment of a dispenser stores the strips of the present invention, with or without perforations, rolled up around a central axis and then allows the ultimate end of the rolled strip to be presented to the user. Another embodiment of the dispenser has segments of the invention joined edge-to-edge in a stacked fashion which allows the user to access single segments at a time. The dispensers described herein allow for a quick and easy dispensing of the strips or segments so that the strips or segments are immediately ready for use and take the mess and guesswork out of preparing and applying the pain management material to the sites needed.

It is therefore an object of the present invention in one or more embodiments to provide devices and methods for protecting the user's mouth from painful contact with orthodontic appliances.

It is also an object of the present invention in one or more embodiments to provide devices and methods for protecting the user's mouth from painful contact with orthodontic appliances that are easy to use.

It is also an object of the present invention in one or more embodiments to provide devices and methods for protecting the user's mouth from contact with orthodontic appliances that allow the user to express him or herself including, without limitation, the presentation of different shapes, colors or icons.

It is therefore an object of the present invention in one or more embodiments to provide devices and methods for protecting the user's mouth from contact with orthodontic appliances or managing pain otherwise caused by contact between the user's mouth and orthodontic appliances that motivates the user to use the device or method by having enticing shapes, colors, flavors or medicaments.

These and other objects and advantages of the invention will be clear in view of the following description to the invention including the associated drawings.

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. In addition, the exact dimensions and dimensional proportions to conform to specific force, weight, strength and similar requirements will be within the skill of the art after the following description has been read and understood.

All Figures are drawn for ease of explanation of the basic teachings of the present invention only; the extensions of the Figures with respect to number, position, relationship, and dimensions of the parts to form examples of the various embodiments will be explained or will be within the skill of the art after the following description has been read and understood.

FIG. 1 is a perspective view of an orthodontic appliance in use in a mouth.

FIG. 2 is a top cross-sectional view of the orthodontic appliance of FIG. 1.

FIG. 3 is a perspective view of one embodiment of the present invention.

FIG. 4 is a front view of the embodiment of the invention of FIG. 3.

FIG. 5 is a top view of the embodiment of the invention of FIG. 3.

FIG. 6 is a perspective view of the dispenser of an embodiment of the invention of FIG. 3.

FIG. 7 is a side cross-sectional view of the dispenser of FIG. 6.

FIG. 8 is a perspective view of the dispenser of an embodiment of the invention of FIG. 3.

FIG. 9 is a side cross-sectional view of the dispenser of FIG. 8.

FIG. 10 is a perspective view of the dispenser of another embodiment of the invention of FIG. 3.

FIG. 11 is a side cross-sectional view of the dispenser of FIG. 10.

FIG. 12 is a front view of an embodiment of the invention.

FIG. 13 is a front view of the strip of the present invention showing examples of various items that could be placed on the front surface of the strip.

FIG. 14 is a front view of an embodiment of the invention.

FIG. 15 is a front view of an embodiment of the invention.

FIG. 16 is a front view of various embodiments of the invention in use.

FIG. 17 is a top cross-sectional view of the invention of FIG. 3 in use.

FIG. 18 is a top cross-sectional view of the invention of FIG. 3 in use including showing mouth tissue.

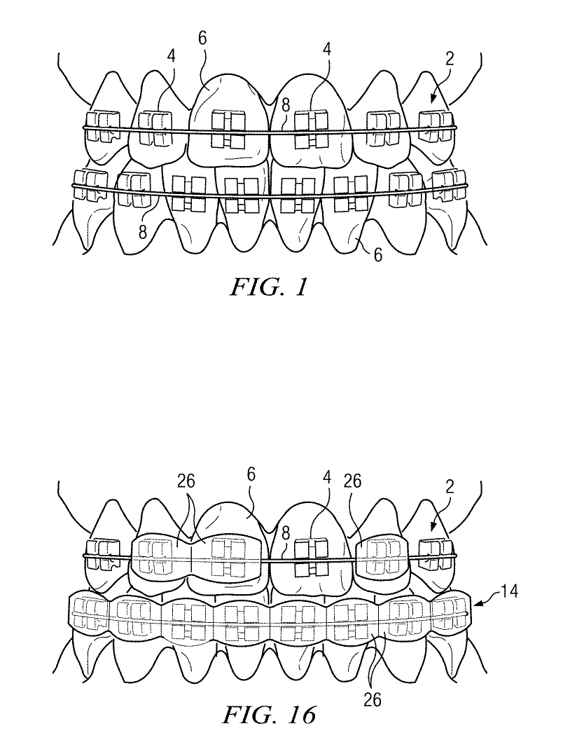

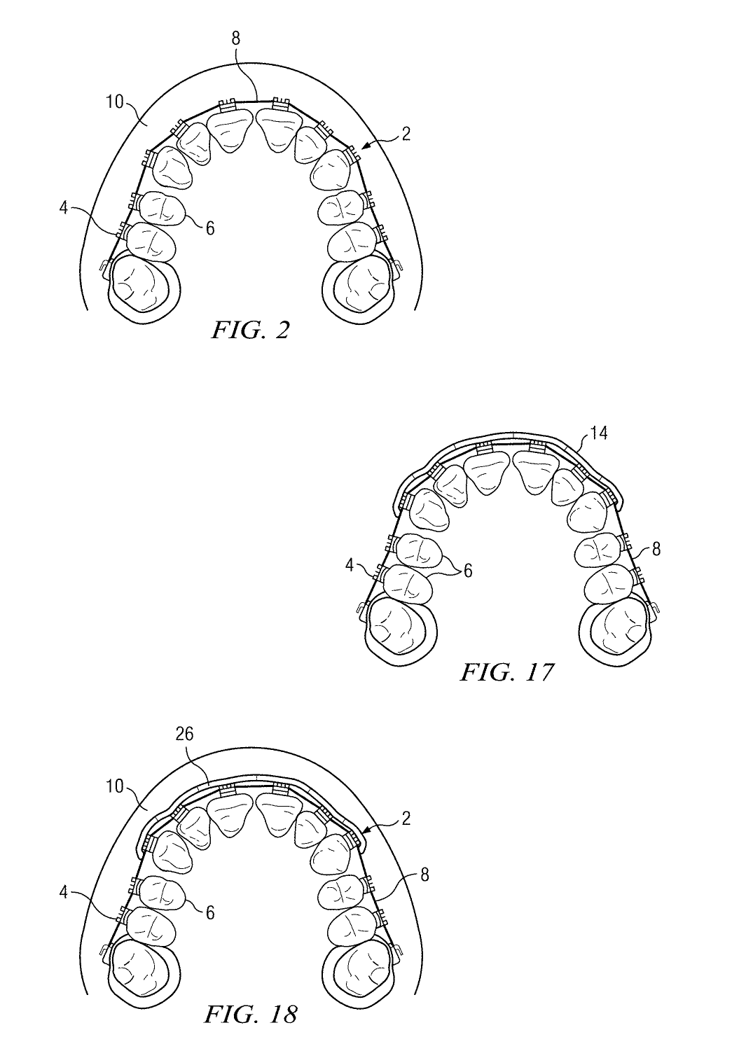

### DETAILED DESCRIPTION OF THE INVENTION

In order that the invention may be clearly understood and readily carried into effect, preferred embodiments of the invention will now be described, by way of example only and not to limit the invention, with reference to the accompanying drawings. The orthodontic pain shield of the present invention is shown in the drawings generally labeled 12.

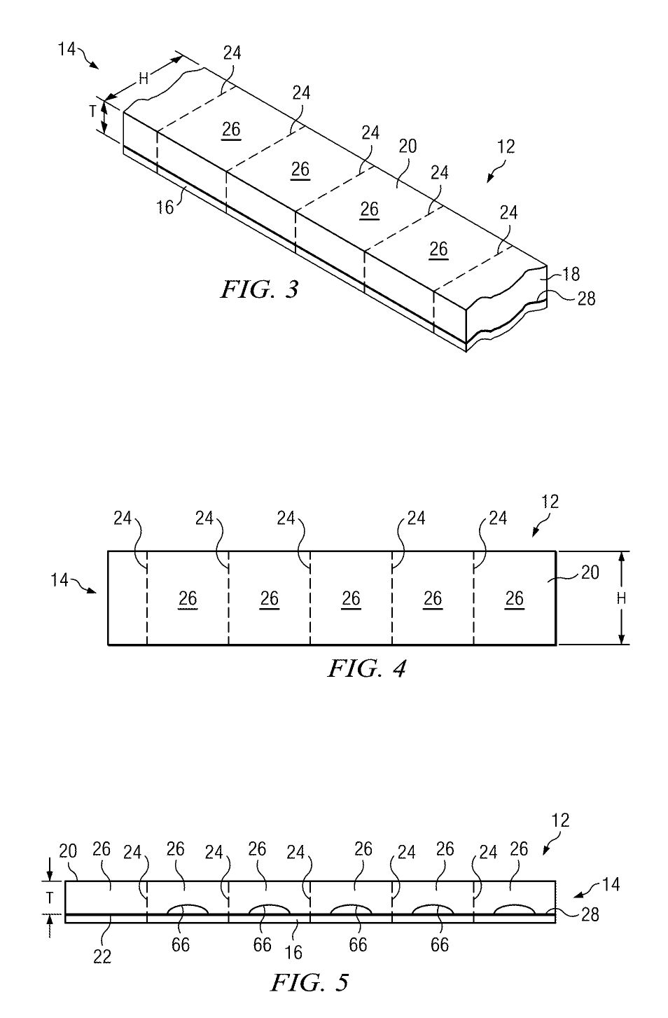

The orthodontic pain shield 12 in a preferred embodiment of the present invention comprises a strip 14 that in whole or in part is applied over the brace or orthodontic appliance to act as a shield between the orthodontic appliance 2 and the mouth 10 of the user. The strip 14, in one embodiment shown in FIGS. 3-5, is a laminate having a substrate 16 and an application layer 18. The application layer 18 has a sufficient height “H” and thickness “T” to cover the raised portion (e.g., bracket 4 or wire 8) of the orthodontic appliance 2 that is causing pain and irritation. The function of the substrate 16 is to provide a base layer to allow the application layer 18 to be easily transported and dispensed but then easily release the application layer 18 when the application layer 18 is to be placed on the orthodontic appliance 2. In addition, the substrate 16 in some embodiments keeps the application layer 18 from coming into contact with itself The strips 14 preferably have a height “H” of about between ¼ to ⅓ of an inch and a thickness “T” between about 1/16 inch to about ¼ inch and more preferably a thickness of about ⅛ of an inch although other sizes and thicknesses may be implemented, depending upon the application as will be clear to those skilled in the art.

The strip 14 includes a front face 20, back face 22 and in one embodiment, includes perforations 24 that are spaced along the strip 14 at desired intervals. These intervals may be regular or at desired intervals, regular or otherwise. The perforations 24 extend through the application layer 18 and substrate 16 and allow the strip 14 to be separated into segments 26. In use as will be described hereafter, the strip 14 or segment 26 should have sufficient length and width to encompass and cover the raised area of the orthodontic appliance 2 that is the cause of irritation to the soft tissues of the mouth 10.

The user can tear along the perforations 24 to form segments 26 of virtually any desired length (subject, of course, to the spacing of the perforations 24) in order to protect a specific area of the user's mouth 10 or an entire arch in the user's mouth 10 that is causing pain and irritation to the soft tissues of the mouth 10. This allows the user to tailor the length of segments 26 needed to a desired length with a quick tear along the perforations 24 between the segments 26. As a result, the user is able to create a segment 26 of relative short length to apply to small areas on the orthodontic appliance 2 or create a segment 26 of relative longer length to allow the relatively longer segment 26 to be applied to large areas, including the whole dental arch if needed. It is likely that individual segments 26 of differing lengths, short, long or in-between, may be needed to adequately cover areas of the mouth 10 as needed.

The material of the strip 14 is pliable enough to bend easily and be placed on the offending braces or orthodontic appliance causing irritation in the mouth 10. Examples of the material of strip 14 include, but are not limited to, dental or orthodontic wax, such as that sold in block form and manufactured by John O. Butler Company of Chicago, Ill. under the trademark GUM®. Although dental or orthodontic wax is the preferred material for the application layer 18, any pliable biocompatible material may be used.

The substrate 16 is preferably a thin film plastic material. The function of the substrate 16 is to provide a good substrate to allow the material of the application layer 18 to be applied and held in position relative to the substrate 16 and to keep the material of the application layer 18 from sticking to itself where the strips 14 are rolled up or stacked as will be described hereafter. Although substrate 16 is preferably a thin film plastic material, any resilient material capable of providing this functionality may be used.

Although this embodiment of the orthodontic pain shield 12 has been described as having a substrate 16 and an application layer 18, a variant of this embodiment dispenses with the substrate 16 and has only the application layer 18. In this variant, the application layer 18 has either to be kept from coming into contract with itself or be a material that does not stick to itself if it does come in contact with itself.

In a preferred method to manufacture the orthodontic pain shield 12 where there is a substrate 16 and an application layer 18, a square of the substrate 16 is laid flat in a single layer upon a non-stick surface. The material of the application layer 18 is applied to the substrate 16. Because the application layer 18 is preferably inherently pliable, the application layer 18 may be readily molded into a desired shape or configuration of the substrate 16. Alternately, the application layer 18 may be heated slightly, for example by immersing it in warm water or applying hot air, to make the application layer 18 more pliable and allow it to be easily dispensed onto the substrate 16. It also may be desirable to place a thin film material 28 between the substrate 16 and the application layer 18 to separate and isolate the application layer 18 from the substrate 16 or allow the application layer 18 to be more easily separated from the substrate 16.

Once the application layer 18 has been applied to the substrate 16, the resulting laminate material is sliced longitudinally to form the strips 14. By way of example only, and not intending to limit the dimensions, where the material of the application layer 18 comes in a 4″×4″ cake, the height “H” is about ¼ to ⅓ of an inch and the thickness “T” is about ⅛ inch, 12-16 strips 14 will typically be produced.

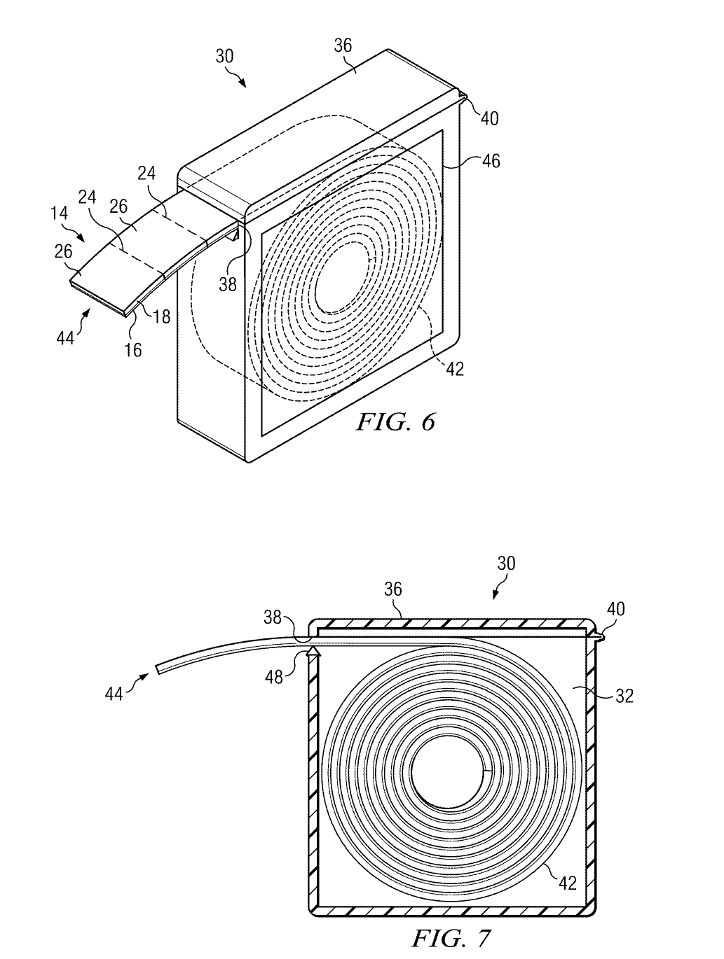

The strips 14 in one embodiment of the orthodontic pain shield 12 shown in FIGS. 6 and 7 are dispensed via a dispenser 30 having a main body 32 with an inner cavity 34, a closable top 36 and a dispensing slot 38. The closable top 36 is attached to the main body via a hinge 40 and covers the inner cavity 34. But, the closable top 36 does not entirely cover the inner cavity 34. Instead, the closable top 36 is dimensioned to not entirely cover the inner cavity so that narrow dispensing slot 38 is produced. Alternately, the closable top 36 may entirely cover the inner cavity 34 but the dispensing slot 38 may be formed in a side wall of the main body 32. In either event, the dispensing slot 38 is dimensioned to allow access to the inner cavity 34 and to allow strips 14 to pass through it as will be described hereafter.

In this embodiment, the strips 14 are rolled into a roll 42 (shown in phantom in FIG. 6) similar to a roll that holds postage stamps. The roll 42 has a terminal end 44. The inner cavity 34 is sized to hold the roll 42. The roll 42 is placed in the inner cavity 34 and the terminal end 44 placed out of the inner cavity 34 through the dispensing slot 38 so that the user may extract strips 14 from the roll 42 by pulling the strips 14 through the dispensing slot 38.

In the embodiment of the orthodontic pain shield 12 using a dispenser 30, the user conveniently unrolls the amount of strip 14 needed from the dispenser 30. Where the strip 14 has perforations 24, when a sufficient length of the strip 14 has passed out of the dispenser 30 through the dispensing slot 38, the user may form a segment 26 by tearing the strip 14 at the perforation 24. Where the strip 14 is a laminate with a substrate 16 and an application layer 18, the application layer 18 is separated from the substrate 16, and thin film material 28 if present, and the substrate 16 and thin film material 28 is discarded.

In a variant of this embodiment, the dispenser 30 includes a sharpened or serrated strip 48 attached at the dispensing slot 38 near where the strip 14 or segment 26 is dispensed from the dispenser 30. The purpose of the sharpened or serrated strip 48 is to sever the strip 14 at desired locations along the strip 14 to form segments 26 of desired length. In this embodiment including the sharpened or serrated strip 48, the strip 14 would typically not include perforations 24 although perforations 24 may be used.

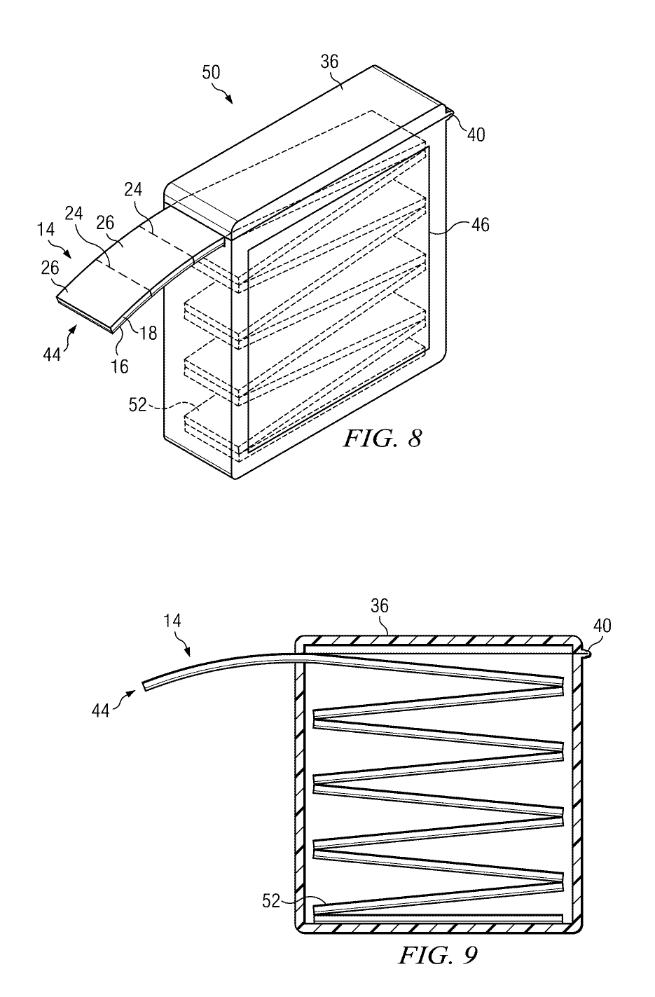

The strip 14 in another embodiment shown in FIGS. 8 and 9 is dispensed from a flip-up type dispenser 50 also having a main body 32 with an inner cavity 34, a closable top 36 and a dispensing slot 38. The closable top 36 is attached to the main body via a hinge 40 and covers the inner cavity 34. But, in this embodiment as well, the closable top 36 does not entirely cover the inner cavity 34. Instead, the closable top 36 is dimensioned to produce a narrow dispensing slot 38. In this embodiment, the strips 14 or individual segments 26 lined up and stacked inside the dispenser 50 in the inner cavity 34 in a zig-zag or Z-shaped configuration (shown in phantom in FIG. 8) with each strip 14 or segment 26 preferably divided by a thin anti-stick layer 52 of wax paper-like material or other similar material. The function of the anti-stick layer 52 is to isolate individual segments 26 or strips 14 from each other for hygienic purposes or to help prevent the individual segments 26 or strips 14 from contacting each other. Although this embodiment preferably has an anti-stick layer 52 as described, it is not required to be used. In a further variant of this embodiment of the orthodontic pain shield 12, individual strips 14 or segments 26 of predetermined length, short, long or in-between, are produced and placed in distinct dispensers 50 holding only strips 14 or segments 26 of the predetermined length to be dispensed to the user as the user desires to cover areas of appropriate size as needed.

In this embodiment, the segments 26 also have a terminal end 44. The inner cavity 34 is sized to hold the stack of strips 14 and the terminal end 44 is placed out of the inner cavity 34 through the dispensing slot 38 so that the user may extract strips 14 from the dispenser 50 by pulling the strips 14 through the dispensing slot 38.

In this embodiment of the orthodontic pain shield 12 using a dispenser 50, the user conveniently pulls the amount of strip 14 needed from the dispenser 50. Where the strip 14 has perforations 24, when a sufficient length of the strip 14 has passed out of the dispenser 50 through the dispensing slot 38, the user may form a segment 26 by tearing the strip 14 at the perforation 24. Where the strip 14 is a laminate with a substrate 16 and an application layer 18, the application layer 18 is separated from the substrate 16, and thin film material 28 if present, and the substrate 16 and thin film material 28 is discarded.

In a variant of this embodiment as well, the dispenser 50 includes a sharpened or serrated strip 48 as described above attached at the dispensing slot 38 near where the strip 14 or segment 26 is dispensed from the dispenser 50 to sever the strip 14 at desired locations along the strip 14 to form segments 26 of desired length. In this embodiment including the sharpened or serrated strip 48, the strip 14 would typically not include perforations 24 although perforations may be used.

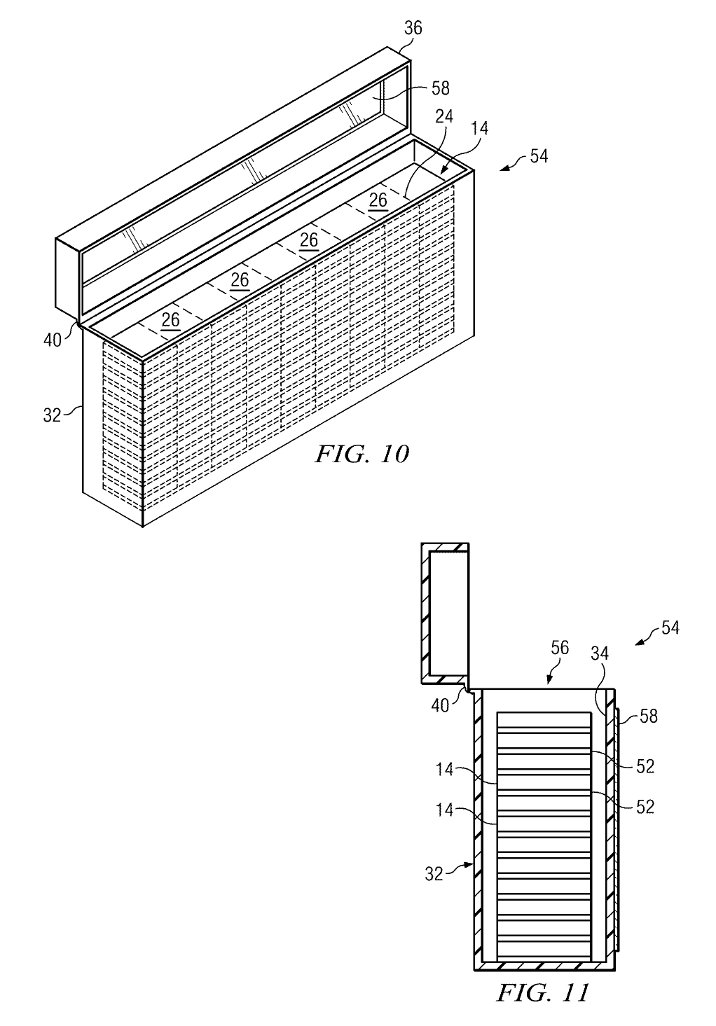

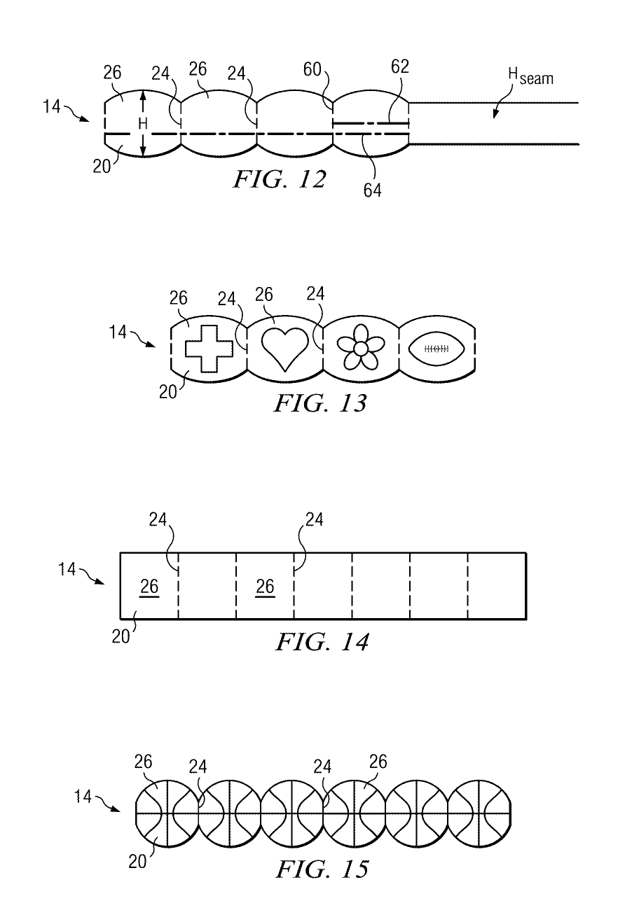

The strip 14 in another embodiment shown in FIGS. 10 and 11 is dispensed from a flip-up type dispenser 54 again having a main body 32 with an inner cavity 34 and a closable top 36 attached to the main body 32 through a hinge 40. However, instead of having a dispensing slot 38, the dispenser 54 has a main opening 56 that is covered by the closable top 36 when the closable top 36 is in its closed position in full contact with the main body 32. The closable top 36 is attached to the main body via a hinge 40 and covers the inner cavity 34 when the closable top is in a down position but allows access to the inner cavity 34 through the main opening 56 when the closable top 36 is in an open position. Although the closable top 36 is preferably attached to the main body 32 by a hinge 40, the closable top 36 may not be attached to the main body 32 via a hinge 40 but may instead be held in place by a lip in frictional contact with the main body 32, by one or more flexible fingers that hold the closable top 36 in contact with the main body in one position and allow the closable top 36 to be moved away from the main body 32 in another position or many other means that will be clear to those skilled in the art.

In this embodiment, the strips 14 or individual segments 26 are stacked on top of each other in the inner cavity 34 of main body 32 of the dispenser 54 (shown in phantom in FIG. 10). It is preferable, but not required, that each strip 14 or segment 26 be separated from the strip 14 or segment 26 above and below it by a thin anti-stick layer 52 of wax paper-like material or other similar material. The function of the anti-stick layer 52 is to isolate individual segments 26 or strips 14 from each other for hygienic purposes or to help prevent the individual segments 26 or strips 14 from contacting each other. In a further variant of this embodiment of the orthodontic pain shield 12, individual segments 26 of predetermined length, short, long or in-between, are produced and placed in distinct dispensers 54 holding only strips 14 or segments 26 of the predetermined length to be dispensed to the user as the user desires to cover areas of appropriate size as needed. In this embodiment, the inner cavity 34 is sized to hold the stack of strips 14 or segments 26. To use this dispenser 54, the user opens the closable top 36 and conveniently grabs a strip 14 or segment from the inner cavity 34 through the main opening 56. Where the strip 14 has perforations 24, the user may form a segment 26 by tearing the strip 14 at the perforation 24. Where the strip 14 is a laminate with a substrate 16 and an application layer 18, the application layer 18 is separated from the substrate 16, and thin film material 28 if present, and the substrate 16 and thin film material 28 is discarded. After the user has removed the desired strip 14 or segment 26 from the inner cavity 34, the user closes the closable top 36. In a variant of this embodiment of the orthodontic pain shield 12, individual segments 26 of predetermined length, short, long or in-between, are produced and placed in distinct dispensers 54 to be dispensed to the user to cover areas of appropriate size as needed.

In a variant of these embodiments involving dispensers 30, 50 or 54, the dispensers 30, 50, 54 also have a mirror 58 affixed to the outside of the dispensers 30, 50, 54 or, with respect to the dispenser 54, on the inside of the closable top 36 so that the user may use the mirror 58 when the closable top 36 is in the open position. The mirror 58 allows the user to see the components of the orthodontic appliance 2 and the applied orthodontic pain shield 12 and judge the effectiveness of the application of the orthodontic pain shield 12 to the orthodontic appliance 2.

These embodiments of the orthodontic pain shield 12 make the orthodontic pain shield 12 able to be readily applied to the user's orthodontic appliances 2 straight from the packaging (e.g., dispenser 30, 50 or 54) or from the strip 14 directly without the need for additional flattening, shaping and molding or the need to guess the proper sizing of strip 14 and thereby more easily cover larger areas.

The strip 14 in yet another embodiment shown in FIG. 12 is a series of individual segments 26 joined together end to end in a sort of caterpillar fashion. In this embodiment, each individual segment 26 is preferably an oval that is joined to its identical neighbor along a seam 60. The long axis 62 of each oval-shaped segment 26 may either be oriented parallel or perpendicular to the axis 64 of the strip 14. Each seam 60 is preferably a part of the substrate 16 and may also be, but is not required to be, perforated at a perforation 24. Whether perforated or not, the substrate 16 of the seam 60 is less in height “H^{seam}” compared to the height H of the substrate 16 associated with each segment 26. As a result, it is relatively easy for the user to tear the seam 60 at a desired location so that user can select a single segment 26 or a series of several segments 26 in a row as desired to be placed on the user's orthodontic appliance 2.

As described above, the length of the segment 26 is determined by separating the strip 14 at desired perforations 24 as needed, or by severing the strip 14 at desired locations by passing the strip 14 across the sharpened or serrated strip 48 or by tearing the strip 14 at a desired location. For some applications, it may be desirable to produce one or more segments 26 of relatively short length to cover a single component of an orthodontic appliance 2. For other applications, it may be desirable to produce one or more segments 26 having a length long enough to cover an entire arch or any length in between a short segment 26 or this longer segment 26.

In any of the embodiments of the strips 14 described herein, the application layer 18 of the strips 14 or individual segments 26 may also be infused with or covered on its front face 20 with flavoring, coloring, antibiotics, topical anesthetic or other medicaments. Also, the strips 14, application layer 18 or segments 26 can be infused with breath fresheners, flavors, including candy flavors, and colors. With respect to the flavors to be used with the present invention, the flavors could be popular flavors such as those sold under the trademark JOLLY RANCHER by Huhtamaki Finance of Hoofddorp Netherlands. Also with respect to flavors, it is highly preferable but not required that such flavors be non-sugar based. In those embodiments of the orthodontic pain shield 12 having antibiotics, topical anesthetics or other medicaments, the front face 20 of the application layer 18 or segments 26 could be infused into or have imprinted onto it the shape of or have a band aid, red cross, angel or other symbol printed on it to represent or indicate healing or comfort.

As mentioned above, the segments 26 or the entire strip 14 may also be colored, including multi-colored. In addition or in the alternative, as shown in FIG. 14, segments 26 or the entire strip 14 may include shapes, figures, symbols, icons, formed, printed or placed on the front face 20 of the segment 26 or strip 14. Examples of these shapes, figures, symbols or icons include but are not limited to flowers, footballs, hearts, baseballs, basketballs, soccer balls, fish, ladybugs, caterpillars, butterflies, stars, diamonds, squares, circles, ovals, rectangles, popular cartoon or movie characters such as Disney® or Pixar characters, professional or college sports team logos, candy or cereal characters, suns, moons, stars, hearts and many more shapes that may be applied limited only by the limits of imagination.

Segment 26 or strip 14, in one embodiment, could also come in candy shapes. This last embodiment would be particularly well adapted to be used in combination with the embodiment described above where the segment 26 or application layer 18 is either infused or coated with a candy flavor.

In a variant of the orthodontic pain shield 12 described above and shown in FIG. 5, an indentation 66 may be preformed on the back side 22 of a segment 26. This indentation 66 allows for self centering of the segment 26 on a bracket 4 as the user applies the segment 26. This allows for easier application of the segment 26 to the orthodontic appliance 2.

In use, as shown in FIGS. 16-18, the user prepares or obtains a segment 26 of appropriate length by any of the methods described above. It may be desirable to prepare or obtain segments 26 of different lengths for covering different parts of the orthodontic appliance 2 or to protect different parts of the mouth. For example, as shown in FIG. 16, segments 26 of one unit, two units or several units, or combinations of these, may be used by the user as desired to cover appropriate pieces of the orthodontic appliance 2 to protect the user's mouth.

In embodiments having a substrate 16 and an application layer 18, the application layer 18 is separated from the substrate 16 to produce the segment 26. The substrate 16, along with any thin film material 28 separating the substrate 16 from the application layer 18, if any, is discarded. The segment 26 is longitudinally aligned with an orthodontic appliance 2, such that the front face 20 faces the orthodontic appliance 2. The user then places the segment 26 over the bracket 4, wire 8 or other offending area of the orthodontic appliance 2 and gently applies pressure to the segment 26. In the segments having an indentation 66, the indentation 66 is placed over the protruding piece of the orthodontic appliance 2. In either event, this allows the segment 26 to form around the bracket 4, wire 8 or other part of the orthodontic appliance 2 thus securely engaging the segment 26 to the orthodontic appliance 2. (FIG. 17)

With the segment 26 in place, whether a relatively short or long segment 26, the segment 26 shields and isolates the irritated soft tissues of the mouth 10 from the rough, abrasive and sharp surfaces of an orthodontic appliance 2 (FIG. 18). Although the segment 26 shields or isolates the irritated soft tissues of the mouth 10 from the offending orthodontic appliance 2 and remains securely in place, the segment 26 is also easy to remove. To remove the segment 26, the user applies slight pressure to the segment 26 to separate it from the exterior of the orthodontic appliance 2. These segments 26 are preferably intended for a single use only and should be disposed of once removed.

The orthodontic pain shield 12 described herein is particularly well adapted for simplicity of use, fun, enjoyment and personnel expression. Unlike prior art devices, the present orthodontic pain shield 12 allows the simplest application available for the use of orthodontic wax.

The orthodontic pain shield 12 of the present invention has the additional key advantage that it can be immediately used straight from its innovative packaging or dispensers 30, 50 or 54, without the need for shaping, flattening, molding or guessing the proper size of the strip 14 or segments 26 and avoids all the mess typically associated with the preparation and application of orthodontic wax. Further, the dispensing method and form of the strips or segments allows for much quicker and easier application for relief of pain for all patients regardless of age. As a result, the orthodontic pain shield 12 of the present invention provides an effective and easy to use device for avoiding the pain caused by the interaction between an orthodontic appliance 2 and the user's mouth that can be used by anyone of any age.

While the above description contains many specificities, these should not be construed as limitations on the scope of the invention, but rather as examples of preferred embodiments thereof. As a result, the description contained herein is intended to be illustrative and not exhaustive. Many variations and alternatives of the described technique and method will occur to one of ordinary skill in this art. Variations in form to the component pieces described and shown in the drawings may be made as will occur to those skilled in the art. Further, although certain embodiments of a orthodontic pain shield 12 have been described, it is also within the scope of the invention to add other additional components or to remove certain components such as the mirror 58. Also, variations in the shape or relative dimensions of the strips 14 or segments 26 will occur to those skilled in the art and still be within the scope of the invention.

All these alternatives and variations are intended to be included within the scope of the attached claims. Those familiar with the art may recognize other equivalents to the specific embodiments described herein which equivalents are also intended to be encompassed by the claims attached hereto. As a result, while the above description contains may specificities, these should not be construed as limitations on the scope of the invention but rather as examples of different embodiments thereof.

1. An orthodontic pain shield comprising:
a strip having sufficient length and width to encompass and cover a raised area of an orthodontic appliance that is the cause of irritation to soft tissues of a mouth wherein the strip includes a front face and a back face;
whereby the strip acts as a shield between the orthodontic appliance and the mouth of the user.

2. The orthodontic pain shield of claim 1 wherein the strip is a laminate having a substrate and an application layer wherein the substrate provides a base layer to allow the application layer to be easily transported and dispensed but then easily release the application layer when the application layer is to be placed on an orthodontic appliance.

3. The orthodontic pain shield of claim 2 wherein the application layer has a sufficient height and thickness to cover a raised portion of an orthodontic appliance that is causing pain and irritation.

4. The orthodontic pain shield of claim 2 wherein the substrate prevents the application layer from coming into contact with itself.

5. The orthodontic pain shield of claim 2 wherein the substrate is a thin film plastic material.

6. The orthodontic pain shield of claim 1 wherein the strip has a height of about between ¼ to ⅓ of an inch.

7. The orthodontic pain shield of claim 1 wherein the strip has a thickness between about 1/16 inch to about ¼ inch.

8. The orthodontic pain shield of claim 7 wherein the strip more preferably has a thickness of about ⅛ of an inch.

9. The orthodontic pain shield of claim 1 wherein the strip includes at least one perforation that is spaced along the strip at desired intervals to allow the strip to be separated into segments of virtually any desired length in order to protect a specific area of the user's mouth or an entire arch in the user's mouth that is causing pain and irritation to the soft tissues of the mouth.

10. The orthodontic pain shield of claim 9 wherein the intervals of the strip formed by the perforations are at regular intervals.

11. The orthodontic pain shield of claim 9 wherein the intervals of the strip formed by the perforations are at desired intervals.

12. The orthodontic pain shield of claim 9 wherein the individual segment is infused with flavoring, coloring, antibiotics, topical anesthetic or other medicaments.

13. The orthodontic pain shield of claim 9 wherein the individual segment is covered on its front face with flavoring, coloring, antibiotics, topical anesthetic or other medicaments.

14. The orthodontic pain shield of claim 9 wherein a segment is colored.

15. The orthodontic pain shield of claim 9 wherein a segment is multi-colored

16. The orthodontic pain shield of claim 9 wherein the front face of a segment includes a visual indicator chosen from the group consisting of shapes, figures, symbols and icons.

17. The orthodontic pain shield of claim 16 wherein the shapes, figures, symbols, icons are chosen from the group consisting of flowers, footballs, hearts, baseballs, basketballs, soccer balls, fish, ladybugs, caterpillars, butterflies, stars, diamonds, squares, circles, ovals, rectangles, popular cartoon characters, movie characters, professional or college sports team logos, candy or cereal characters, suns, moons, stars and hearts.

18. The orthodontic pain shield of claim 9 wherein the segment is infused with a breath freshener.

19. The orthodontic pain shield of claim 9 wherein the segment is infused with a flavor.

20. The orthodontic pain shield of claim 19 wherein the flavor is a candy flavor.

21. The orthodontic pain shield of claim 9 wherein the segment is infused with a color.

22. The orthodontic pain shield of claim 1 wherein the material of the strip is pliable enough to bend easily and be placed on a desired orthodontic appliance causing irritation in a mouth.

23. The orthodontic pain shield of claim 22 wherein the material of the strip is chosen from the group consisting of dental or orthodontic wax.

24. The orthodontic pain shield of claim 1 wherein the strip is a series of individual segments joined together end to end.

25. The orthodontic pain shield of claim 24 wherein each individual segment is an oval that is joined to its identical neighbor along a seam.

26. The orthodontic pain shield of claim 25 wherein each seam is part of a substrate.

27. The orthodontic pain shield of claim 25 wherein each seam is perforated.

28. The orthodontic pain shield of claim 25 wherein the strip has an axis and each oval-shaped segment has an axis and wherein the axis of the strip and the axis of each oval-shaped segment are parallel.

29. The orthodontic pain shield of claim 25 wherein the strip has a an axis and each oval-shaped segment has an axis and wherein the axis of the strip and the axis of each oval-shaped segment are perpendicular.

30. The orthodontic pain shield of claim 1 wherein the strip is infused with flavoring, coloring, antibiotics, topical anesthetic or other medicaments.

31. The orthodontic pain shield of claim 1 wherein the strip is covered on its front face with flavoring, coloring, antibiotics, topical anesthetic or other medicaments.

32. The orthodontic pain shield of claim 31 wherein the antibiotics, topical anesthetic or other medicaments is imprinted onto the front face in a shape to represent or indicate healing or comfort.

33. The orthodontic pain shield of claim 1 wherein the strip is a laminate having a substrate and an application layer wherein the application layer of the strip is infused with flavoring, coloring, antibiotics, topical anesthetic or other medicaments.

34. The orthodontic pain shield of claim 1 wherein the strip is a laminate having a substrate and an application layer wherein the application layer of the strip is covered on its front face with flavoring, coloring, antibiotics, topical anesthetic or other medicaments.

35. The orthodontic pain shield of claim 34 wherein the antibiotics, topical anesthetic or other medicaments are imprinted onto the front face in a shape to represent or indicate healing or comfort.

36. The orthodontic pain shield of claim 1 wherein the strip is infused with a breath freshener.

37. The orthodontic pain shield of claim 1 wherein the strip is infused with a flavor.

38. The orthodontic pain shield of claim 37 wherein the flavor is a candy flavor.

39. The orthodontic pain shield of claim 1 wherein the strip is infused with a color.

40. The orthodontic pain shield of claim 39 wherein the strip is multi-colored.

41. The orthodontic pain shield of claim 1 wherein the strip is a laminate having a substrate and an application layer wherein the application layer is infused with a breath freshener.

42. The orthodontic pain shield of claim 1 wherein the strip is a laminate having a substrate and an application layer wherein the application layer is infused with a flavor.

43. The orthodontic pain shield of claim 42 wherein the flavor is a candy flavor.

44. The orthodontic pain shield of claim 1 wherein the strip is infused with a color.

45. The orthodontic pain shield of claim 1 wherein the front face of a strip includes a visual indicator chosen from the group consisting of shapes, figures, symbols or icons.

46. The orthodontic pain shield of claim 45 wherein the shapes, figures, symbols, icons are chosen from the group consisting of flowers, footballs, hearts, baseballs, basketballs, soccer balls, fish, ladybugs, caterpillars, butterflies, stars, diamonds, squares, circles, ovals, rectangles, popular cartoon characters, movie characters, professional or college sports team logos, candy or cereal characters, suns, moons, stars and hearts.

47. The orthodontic pain shield of claim 46 wherein the shape is a candy shape.

48. The orthodontic pain shield of claim 1 wherein the back side includes an indentation preformed on the back side whereby the indentation allows for self centering of a portion of the strip as a user applies strip to an orthodontic appliance.

49. A method of manufacturing an orthodontic pain shield having a substrate and an application layer comprising the steps of:
laying a square of the substrate in a single layer upon a non-stick surface;
applying the material of the application layer to the substrate;
molding the application layer into a desired shape or configuration of the substrate; and
slicing the resulting laminate material is sliced longitudinally to form strips.

50. The method of claim 49 further comprising the step, to be performed between the steps of laying a square of the substrate in a single layer upon a non-stick surface and applying the material of the application layer to the substrate, of placing a thin film material between the substrate and the application layer to separate and isolate the application layer from the substrate or allow the application layer to be more easily separated from the substrate.

51. A method of manufacturing an orthodontic pain shield having a substrate and an application layer comprising the steps of:
laying a square of the substrate in a single layer upon a non-stick surface;
applying the material of the application layer to the substrate;
heating the application layer until the application layer is pliable;
dispensing the application layer in a desired shape or configuration onto the substrate; and
slicing the resulting laminate material is sliced longitudinally to form strips.

52. The method of claim 51 further comprising the step, to be performed between the steps of laying a square of the substrate in a single layer upon a non-stick surface and applying the material of the application layer to the substrate, of placing a thin film material between the substrate and the application layer to separate and isolate the application layer from the substrate or allow the application layer to be more easily separated from the substrate.

53. A dispenser for strips of an orthodontic pain shield comprising:
a main body with an inner cavity sized to hold a roll of orthodontic pain shield strips;
a closable top attached to the main body via a hinge and dimensioned to cover the inner cavity except for a dispensing slot;
wherein orthodontic pain shield strips in a roll having a terminal end are placed in the inner cavity so that the terminal end is placed out of the inner cavity through the dispensing slot so that the user may extract strips from the roll by pulling the strips through the dispensing slot.

54. The dispenser of claim 53 further comprising a sharpened or serrated strip attached at the dispensing slot near where the strip or segment is dispensed from the dispenser to sever the strip at desired locations along the strip to form segments of a desired length.

55. A dispenser for strips of an orthodontic pain shield comprising:
a main body with an inner cavity sized to hold a roll of strips and having a dispensing slot;
a closable top attached to the main body via a hinge and dimensioned to cover the inner cavity;
wherein strips in a roll having a terminal end are placed in the inner cavity so that the terminal end is placed out of the inner cavity through the dispensing slot so that the user may extract strips from the roll by pulling the strips through the dispensing slot.

56. The dispenser of claim 55 further comprising a sharpened or serrated strip attached at the dispensing slot near where the strip or segment is dispensed from the dispenser to sever the strip at desired locations along the strip to form segments of desired length.

57. The dispenser of claim 55 further comprising a mirror affixed to the outside of the dispenser.

58. A dispenser for strips of an orthodontic pain shield comprising:
a main body with an inner cavity sized to hold a stack of strips;
a closable top attached to the main body via a hinge and dimensioned to cover the inner cavity except for a dispensing slot;
wherein the strips or individual segments having a terminal end are lined up and stacked inside the dispenser in the inner cavity in a zig-zag or Z-shaped configuration and
wherein the terminal end is placed out of the inner cavity through the dispensing slot so that the user may extract strips from the dispenser by pulling the strips through the dispensing slot.

59. The dispenser of claim 58 further comprising a sharpened or serrated strip attached at the dispensing slot near where the strip or segment is dispensed from the dispenser to sever the strip at desired locations along the strip to form segments of desired length.

60. The dispenser of claim 58 further comprising a mirror affixed to the outside of the dispenser.

61. A dispenser for strips of an orthodontic pain shield comprising:
a main body with an inner cavity sized to hold a stack of strips, the main body having a dispensing slot;
a closable top attached to the main body via a hinge and dimensioned to cover the inner cavity;
wherein the strips or individual segments having a terminal end are lined up and stacked inside the dispenser in the inner cavity in a zig-zag or Z-shaped configuration and
wherein the terminal end is placed out of the inner cavity through the dispensing slot so that the user may extract strips from the dispenser by pulling the strips through the dispensing slot.

62. The dispenser of claim 61 further comprising a sharpened or serrated strip attached at the dispensing slot near where the strip or segment is dispensed from the dispenser to sever the strip at desired locations along the strip to form segments of desired length.

63. The dispenser of claim 61 further comprising a mirror affixed to the outside of the dispenser.

64. A dispenser for strips of an orthodontic pain shield comprising:
a main body with an inner cavity sized to hold the stack of strips or segments and a main opening; and
a closable top attached to the main body and covering the main opening when the closable top is in a closed position and allowing access to the inner cavity when the closable top is in an open position;
wherein the strips or individual segment is stacked on top of each other in the inner cavity of main body of the dispenser; and
wherein the user opens the closable top and conveniently grabs a strip or segment from the inner cavity through the main opening.

65. The dispenser of claim 64 further comprising a mirror affixed to the outside of the dispenser.

66. The dispenser of claim 64 further comprising a mirror affixed to the inside of the closable top.

67. A method of preventing pain in a mouth due to contact between an orthodontic appliance and the mouth comprising the steps of:
providing an orthodontic pain shield comprising:
a strip having sufficient length and width to encompass and cover a raised area of an orthodontic appliance that is the cause of irritation to soft tissues of a mouth wherein the strip includes a front face and a back face;
preparing a segment from the strip of a desired length;
applying the segment to the orthodontic appliance;
whereby the strip acts as a shield between the orthodontic appliance and the mouth of the user.

68. In a system capable of being used immediately straight from its packaging without the need for shaping, flattening, molding or guessing the proper size of its elements in order to avoid all the mess typically associated with the preparation and application of orthodontic wax, a method of preventing pain in a mouth due to contact between an orthodontic appliance and the mouth comprising the steps of:
providing an orthodontic pain shield comprising:
a strip having sufficient length and width to encompass and cover a raised area of an orthodontic appliance that is the cause of irritation to soft tissues of a mouth wherein the strip includes a front face and a back face;
preparing a segment from the strip of a desired length;
applying the segment to the orthodontic appliance;
whereby the strip acts as a shield between the orthodontic appliance and the mouth of the user.
